(19) United States
(12) Patent Application Publication
(10) Pub. No.: US 2020/0247530 A1
(43) Pub. Date: Aug. 6, 2020

(54) METHOD FOR CONTROLLING A PLAY IN A FLIGHT CONTROL SURFACE OF AN AIRCRAFT AND ASSOCIATED CONTROL SYSTEM

(71) Applicant: DASSAULT AVIATION, Paris (FR)

(72) Inventor: Sylvain HUET, Saint-Cloud (FR)

(21) Appl. No.: 16/781,266

(22) Filed: Feb. 4, 2020

(30) Foreign Application Priority Data
Feb. 6, 2019 (FR) 19 01175

(51) Int. Cl. B64C 13/50

(52) U.S. Cl. CPC B64C 13/50

(57) ABSTRACT

A method for controlling a play in a flight control surface (12) of an aircraft, implemented by a control system, includes sending a sinusoidal excitation signal; measuring a response signal corresponding to the evolution of a parameter representative of the response of the flight control surface (12) to the sinusoidal excitation signal; processing the response signal to determine the play in the flight control surface (12). The processing includes determining a characteristic variable of an odd harmonic of the response signal other than the first harmonic of the response signal; and determining the play from the characteristic variable with an abacus curve.

The present disclosure relates to a method for controlling a play in a flight control surface of an aircraft, implemented by a control system, the method comprising the following steps:
sending a sinusoidal excitation signal;
measuring a response signal corresponding to the evolution of a parameter representative of the response of the flight control surface to the excitation signal;
processing the response signal to determine the play in the flight control surface.

The present disclosure applies to aircraft used in civil aviation, in particular in business aviation.

### BACKGROUND

An aircraft flight control surface typically comprises an actuator configured to control the orientation of a moving surface, by means of a mechanical chain. The change of orientation of the moving surface generates an aerodynamic force that makes it possible to control the orientation of the aircraft along its pitch, roll or yaw axis.

The mechanical chain of such a flight control surface comprises a certain number of screws, bolts, actuators and other parts. Each of these parts can have a mechanical play.

These mechanical plays accumulate to form a total mechanical play for the flight control surface. This total mechanical play in particular corresponds to an angular control range of the moving part around an initial angular position for which the torque applied on the moving part by the mechanical chain is nil.

Such a total mechanical play therefore involves a shift between a control signal upstream from the mechanical chain and an actual movement of the moving surface. This play can produce difficulties in the piloting of the aircraft.

In the field of civil aviation, it becomes necessary to demonstrate that the value of this total mechanical play is below a threshold value. This total mechanical play must therefore be determined.

To that end, it is known to determine it by performing cumbersome and time-consuming static tests, these tests requiring the involvement of specialists. These tests cause a long immobilization of the aircraft.

Also known is a dynamic method for controlling a play in a flight control surface of an aircraft comprising sending an excitation signal, measuring a response signal of the flight control surface to the excitation signal and processing the response signal to determine the play in the flight control surface.

Although this method is quick and inexpensive, it depends on the inertia of the flight control surface and the hydraulic stiffness of the actuator, which can vary enough during production to make the measurement imprecise.

### SUMMARY

One aim of the present disclosure is therefore to provide a method making it possible to determine a play in a flight control surface of an aircraft that is simple to implement, reliable, precise and fast.

To that end, a method for controlling a play in a flight control surface of an aircraft of the aforementioned type is provided, wherein the processing step comprises the following sub-steps:
determining a characteristic variable of an odd harmonic of the response signal other than the first harmonic of the response signal; and
determining said play from said characteristic variable with an abacus curve.

The method according to the invention may include one or more of the following features, considered alone or according to any technically possible combinations:
the processing step comprises determining a ratio between a value of the characteristic variable corresponding to the first harmonic of the response signal and a value of said characteristic variable corresponding to said odd harmonic of the response signal, and the step for determining said play comprises comparing a representative parameter of said determined ratio with the abacus curve;
said other odd harmonic is the third harmonic or the fifth harmonic;
said characteristic variable corresponding to a given harmonic is an area of a curve representative of the Fourier transform of the response signal, the area being taken between two frequencies each corresponding to a predefined attenuation relative to said given harmonic;
the attenuation is greater than −1 dB, advantageously between −1 dB and −5 dB, preferably between −2 dB and −4 dB, still more preferably equal to −3 dB;
said characteristic variable is the amplitude, at a corresponding harmonic, of a Fourier transform of the response signal;
the flight control surface comprises a fixed part relative to a structure of the aircraft and a moving part relative to the fixed part, the excitation signal being a control signal of an angular movement of the moving part of the flight control surface relative to the fixed part, the representative parameter of the response of the flight control surface to the excitation signal being representative of an angular movement of the moving part relative to the fixed part;
the abacus curve is a predetermined curve linking said representative parameter of said ratio to a factor dependent on said play;
the excitation signal has a predetermined amplitude, the factor depending on said play depending on the ratio between said play and the amplitude of the excitation signal;
the excitation signal has a single predetermined excitation frequency, the predetermined excitation frequency preferably being between 0.5 Hz and 5 Hz, advantageously between 1.25 Hz and 5 Hz;
the excitation signal is sent during a predetermined time period, the predetermined time period being at least greater than 10 seconds, preferably greater than 30 seconds, advantageously greater than 1 minute;
the method comprises a step for communicating a piece of information representative of said determined play to a user, the communication step comprising displaying said representative piece of information; and
the excitation signal is sent by an actuator of the flight control surface.

A system for controlling a play in a flight control surface of an aircraft is also provided comprising:
an excitation module configured to send a sinusoidal excitation signal;
a measuring module configured to measure a response signal corresponding to the evolution of a parameter representative of the response of the flight control surface to the excitation signal;
a processing module configured to determine a characteristic variable of an odd harmonic of the response signal other than the first harmonic of said response signal and to determine the play from said characteristic variable with an abacus curve.

The control system optionally comprises the following features:
the processing module is configured to determine a ratio between a value of the characteristic variable corresponding to the first harmonic of the response signal and a value of said characteristic variable corresponding to said odd harmonic of the response signal, and the step for determining said play by comparing a representative parameter of said determined ratio with an abacus curve; and
the processing module is integrated into an avionics system of the aircraft or is integrated into an external housing able to be separated from the aircraft and to be connected on an actuator of the flight control surface.

### BRIEF SUMMARY OF THE DRAWINGS

The invention will be better understood upon reading the following description, provided solely as an example and done in reference to the appended drawings, in which:

FIG. 1 is a schematic illustration of one embodiment of the system for controlling a play of a flight control surface according to an embodiment of the invention;

FIG. 2 is a schematic side illustration of a flight control surface whereof the mechanical play is controlled by the control system of FIG. 1;

FIG. 3 is a graph illustrating an exemplary curve representative of the Fourier transform of the response signal of the flight control surface;

FIG. 4 is a graph illustrating an exemplary abacus curve used; and

FIG. 5 is a flowchart of a control method according to an embodiment of the invention.

### DETAILED DESCRIPTION

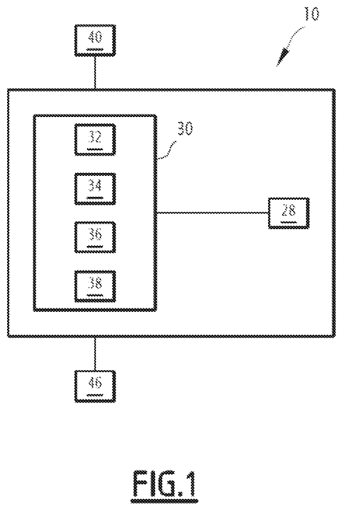

A control system 10 for controlling a play in a flight control system 12 of an aircraft according to an embodiment of the invention is illustrated in FIG. 1.

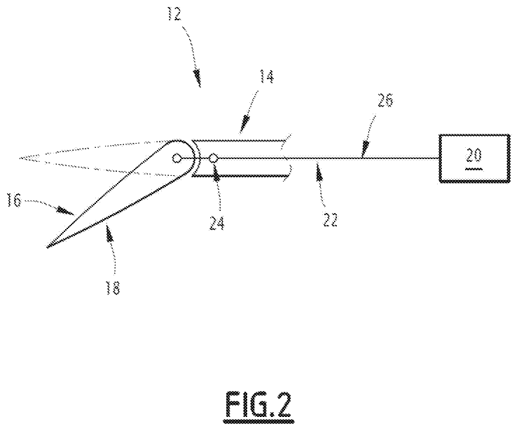

The flight control surface 12, illustrated in FIG. 2, comprises a stationary part 14 relative to a structure of the aircraft and a moving part 16 relative to the stationary part 14.

The moving part 16 is in contact with a mass of air outside the aircraft. It has a surface 18 whereof the change of orientation relative to said stationary part 14 generates an aerodynamic force.

As illustrated in FIG. 2, the moving part 16 is typically rotatable relative to the stationary part 14 between at least two positions, respectively illustrated in solid lines and mixed lines in FIG. 2.

The moving part 16 is for example configured so that said surface 18 makes it possible to control the orientation of the aircraft along its pitch, roll or yaw axis.

The flight control surface 12 also comprises an actuator 20 configured to control the orientation of the moving part 16, by means of a mechanical chain 22.

The actuator 20 is for example a servo-control.

The actuator 20 is typically connected to an avionics system of the aircraft.

The mechanical chain 22 comprises a plurality of assembly members 24, such as screws and/or bolts.

The mechanical chain 22 also comprises transmission members 26 able to convert a control signal of the actuator 20 into angular movement of the moving part 16.

At least one transmission member 26 is able to convert the control signal into rectilinear movement. Additionally, at least one transmission member 26 is able to convert the rectilinear movement into angular movement of the moving part 16.

At least one of these members 24, 26 has a mechanical play. All of the mechanical play(s) of the members 24, 26 leads to a total mechanical play Jt associated with the flight control surface 12.

This total mechanical play Jt in particular corresponds to an angular control range of the moving part 16 around an initial angular position for which the torque applied on the moving part 16 by the mechanical chain 22 is nil.

This total mechanical play will also be called “play of the flight control surface” hereinafter.

The control system 10 is configured to determine the total mechanical play Jt of the flight control surface 12.

To that end, the control system 10 comprises at least one processor 28 and a memory 30.

The control system 10 comprises an excitation module 32, a measuring module 34 and a processing module 36. Preferably, it also comprises a communication module 38 for communicating with a user.

For example, each of these modules 32, 34, 36, 38 is made in the form of software stored in the memory 30 and able to be executed by the processor 28. In a variant, each of the modules 32, 34, 36, 38 is at least partially made in the form of a programmable logic component, or in the form of a dedicated integrated circuit, included in the control system 10.

In one embodiment, each of these modules 32, 34, 36, 38 is integrated into the avionics system of the aircraft. In a variant, each of these modules 32, 34, 36, 38 is integrated into a non-embedded computer, for example a PC or a tablet.

The excitation module 32 is configured to send a sinusoidal excitation signal.

In particular, the excitation module 32 is configured to control the sending of the excitation signal by the actuator 20 of the flight control surface 12.

The excitation signal is a control signal of an angular movement of the moving part 16 of the flight control surface 12 relative to the stationary part 14.

The excitation signal has a single predetermined excitation frequency. “A single predetermined excitation frequency” means that a Fourier transform of the excitation signal may comprise other frequencies, but that the respective amplitude associated with these frequencies is less than 10%, preferably than 5%, of the amplitude associated with said predetermined excitation frequency.

The predetermined excitation frequency depends on the actuator.

The predetermined excitation frequency is for example between 0.5 Hz and 5 Hz, advantageously between 1.25 Hz and 5 Hz.

The excitation signal has a predetermined amplitude A.

The amplitude A of the excitation signal is predetermined so that an evolution of a parameter representative of the response of the flight control surface 12 to the excitation signal can be measured, as disclosed below. “Parameter representative of the response” here and hereinafter means that the evolution and the value of the parameter depend on the response.

The excitation module 32 is configured to send the excitation signal during a predetermined time period.

The predetermined time period is at least greater than 10 seconds, preferably greater than 30 seconds, advantageously greater than 1 minute.

The measuring module 34 is configured to measure a response signal corresponding to the evolution of a parameter representative of the response of the flight control surface 12 to the excitation signal.

Said evolution is a time evolution of said representative parameter.

The parameter representative of the response of the flight control surface 12 to the excitation signal is for example representative of an angular movement of the moving part 16 relative to the stationary part 14.

The measuring module 34 is connected to sensors 40 able to measure the evolution of said representative parameter.

These sensors 40 are for example accelerometers.

The processing module 36 is configured to determine a characteristic variable of an odd harmonic of the response signal other than the first harmonic of said response signal and to determine the play Jt of the flight control surface 12 with an abacus curve 44, as described in detail hereinafter.

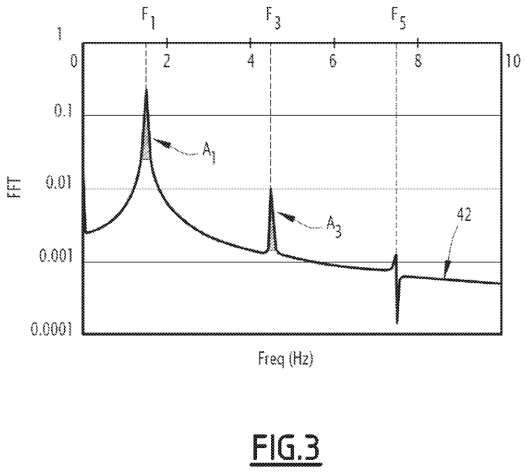

To that end, as illustrated in FIG. 3, the processing module 36 is configured to implement a Fourier transform of the response signal.

The Fourier transform FFT obtained by this transform in particular has a first harmonic F1 corresponding to the predetermined excitation frequency and a plurality of other harmonics F3, F5.

Advantageously, the processing module 36 is configured to determine said play Jt from a ratio Rd of two values, one to the other, of a same characteristic variable of the response signal.

The ratio Rd determined by the processing module 36 is between a value of the characteristic variable corresponding to the first harmonic F1 of the response signal and a value of said characteristic variable corresponding to another odd harmonic F3, F5 of the response signal.

Advantageously, the determined ratio Rd is that of the value of the characteristic variable corresponding to the first harmonic F1 of the response signal to the value of said characteristic variable corresponding to another odd harmonic F3, F5 of the response signal.

In a variant, the determined ratio Rd is that of the value of the characteristic variable corresponding to another odd harmonic F3, F5 of the response signal to the value of said characteristic variable corresponding to the first harmonic F1 of the response signal.

Said other odd harmonic is advantageously the third harmonic F3. In a variant, said other odd harmonic is the fifth harmonic F5.

In one advantageous embodiment, illustrated in FIG. 3, the advantageously, the characteristic variable corresponding to a given harmonic is an area A1, A3 of a curve 42 representative of the Fourier transform of the response signal in a graph depicting this transform as a function of the frequency, the area being taken between two frequencies each corresponding to a predefined attenuation relative to said given harmonic.

As illustrated in FIG. 3, said curve 42 representative of the Fourier transform of the response signal is preferably a spectral density curve, in particular linking the modulus as a function of the respective frequency, said graph for example having a logarithmic scale on the y-axis.

In the example of FIG. 3, for clarity reasons, only the odd harmonics have been shown. In practice, the transform also has even harmonics.

“Area of a curve” refers to the area below or above the curve 42. This area is shown crosshatched in FIG. 3.

The predefined attenuation is preferably greater than −1 dB, advantageously between −1 dB and −5 dB, preferably between −2 dB and −4 dB, still more preferably equal to −3 dB.

Said area A1, A3 is closed and for example bounded by a constant straight y-axis line in said graph, for example by the line corresponding to the predefined attenuation relative to the given harmonic.

Thus, the determined ratio Rd is, in this example, between the area A3 of the Fourier transform taken between two frequencies corresponding to a attenuation of −3 dB around the third harmonic and the area A1 of the Fourier transform taken between two frequencies corresponding to a attenuation of −3 dB around the first harmonic F1.

Furthermore, the processing module 36 is configured to determine said play Jt of the flight control surface 12 by comparing a parameter representative of said determined ratio Rd with the abacus curve 44.

The abacus curve 44 is a predetermined curve linking said representative parameter of the ratio Rd to a factor G dependent on said play Jt of the flight control surface 12.

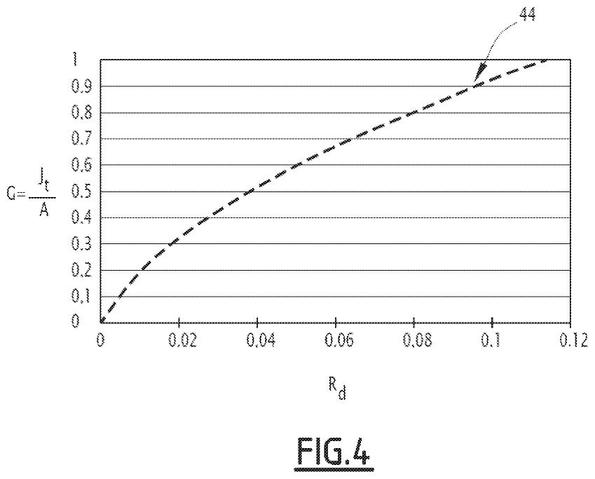

An example used abacus curve 44 is illustrated in FIG. 4.

In the illustrated example, the representative parameter corresponds to said determined ratio Rd.

In particular, the factor G depending on said play Jt advantageously depends on the ratio between said play Jt and the amplitude A of the excitation signal. The factor G is preferably equal to the ratio between said play Jt and the amplitude A of the excitation signal.

The abacus curve 44 is predetermined by a series of tests upstream from the implementation of the control method according to an embodiment of the invention, in particular upstream from the sending of the excitation signal.

The use of such an abacus curve 44 makes it possible not to depend on the inertia of the flight control surface 12 or on the frequency of the excitation signal, or the amplitude A of the excitation signal, or the stiffness of the mechanical chain 22.

The communication module 38 is configured to communicate a piece of information representative of said determined play Jt to a user.

To that end, the communication module 38 is configured to display said representative information on a screen 46 intended for the user.

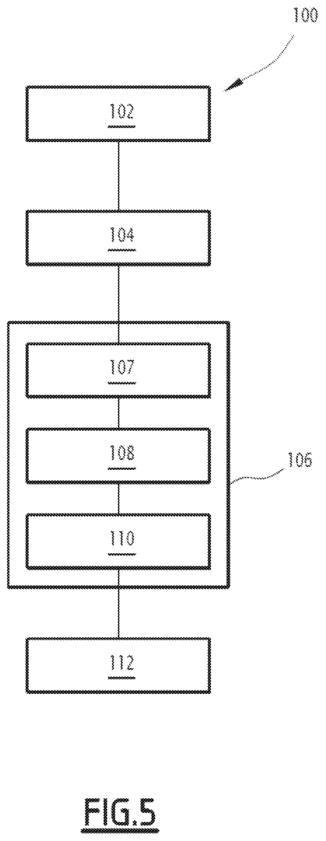

A method 100 for controlling a play Jt in the flight control surface 12 will now be disclosed, in reference to FIG. 5.

The method 100 is advantageously implemented by computer, in particular by the control system 10 disclosed above. The method is for example implemented by a service station during a maintenance operation on the aircraft, or during inspections done before the departure of the aircraft, during flight, in the parking area or during taxi.

The method 100 comprises sending 102 the sinusoidal excitation signal, and measuring 104 the response signal corresponding to the evolution of the parameter representative of the response of the flight control surface 12 to the excitation signal.

This sending 102 is carried out by the excitation module 32, and this measurement 104 is carried out by the measuring module 34 and the sensors 40.

The response signal is next processed to determine the play Jt in the flight control surface 12.

This processing 106 is carried out by the processing module 36.

As described above, the processing comprises determining 107 a characteristic variable of an odd harmonic of the response signal other than the first harmonic of said response signal.

To that end, the processing comprises determining the Fourier transform of the measured response signal.

The processing 106 then comprises determining 110 said play Jt from said characteristic variable of the odd harmonic with an abacus curve 44.

To that end, the processing 106 advantageously comprises determining 108 said ratio Rd between the value of the characteristic variable corresponding to the first harmonic F1 of the response signal and the value of said characteristic variable corresponding to the other odd harmonic.

The determination 110 of said play Jt comprises comparing a parameter representative of said determined ratio Rd with the abacus curve 44 described above.

The method 100 also advantageously comprises the communication 112 of the piece of information representative of said determined play Jt to a user, this communication step 112 comprising displaying said representative piece of information.

This communication 112 is carried out by the communication module 38.

In one embodiment variant, said characteristic variable is the amplitude, at a corresponding harmonic, of a Fourier transform of the response signal.

In a variant, the processing module 36 is integrated into an external housing able to be separated from the aircraft and to be connected on the actuator 20 of the flight control surface 12.

Such a housing can also comprise at least one, several or all of the other modules disclosed above.

Owing to the features described above, the determination of the play in the flight control surface 12 is easy to implement, reliable, precise and fast.

It does not require specific instrumentation, or outside testing means.

What is claimed is:

1. A method for controlling a play in a flight control surface of an aircraft, the method being implemented by a control system, the method comprising:
sending a sinusoidal excitation signal;
measuring a response signal corresponding to an evolution of a parameter representative of a response of the flight control surface to the sinusoidal excitation signal;
processing the response signal to determine the play in the flight control surface,
the processing comprising:
determining a characteristic variable of an odd harmonic of the response signal other than the first harmonic of the response signal; and
determining the play from the characteristic variable with an abacus curve.

2. The method according to claim 1, wherein the processing comprises determining a ratio between a value of the characteristic variable corresponding to the first harmonic of the response signal and a value of the characteristic variable corresponding to the odd harmonic of the response signal, and the determining the play comprises comparing a representative parameter of the determined ratio with the abacus curve.

3. The method according to claim 1, wherein the odd harmonic is the third harmonic or the fifth harmonic.

4. The method according to claim 1, wherein the characteristic variable corresponding to the odd harmonic is an area of a curve representative of the Fourier transform of the response signal, the area being taken between two frequencies each corresponding to a predefined attenuation relative to the odd harmonic.

5. The method according to claim 4, wherein the attenuation is greater than −1 dB.

6. The method according to claim 5, wherein the attenuation is comprised between −1 dB and −5 dB.

7. The method according to claim 1, wherein the characteristic variable is an amplitude, at the odd harmonic, of a Fourier transform of the response signal.

8. The method according to claim 1, wherein the flight control surface comprises a fixed part fixed relative to a structure of the aircraft and a moving part movable relative to the fixed part, the sinusoidal excitation signal being a control signal of an angular movement of the moving part of the flight control surface relative to the fixed part, the parameter representative of the response of the flight control surface to the sinusoidal excitation signal being representative of an angular movement of the moving part relative to the fixed part.

9. The method according to claim 1, wherein the processing comprises determining a ratio between a value of the characteristic variable corresponding to the first harmonic of the response signal and a value of the characteristic variable corresponding to the odd harmonic of the response signal, and the determining the play comprises comparing a representative parameter of the determined ratio with the abacus curve, and wherein the abacus curve is a predetermined curve linking the representative parameter of the ratio to a factor dependent on the play.

10. The method according to claim 9, wherein the sinusoidal excitation signal has a predetermined amplitude, the factor depending on the play depending on the ratio between the play and the predetermined amplitude of the sinusoidal excitation signal.

11. The method according to claim 1, wherein the sinusoidal excitation signal has a single predetermined excitation frequency.

12. The method according to claim 11, wherein the single predetermined excitation frequency is comprised between 0.5 Hz and 5 Hz.

13. The method according to claim 1, wherein the sinusoidal excitation signal is sent during a predetermined time period, the predetermined time period being at least greater than 10 seconds.

14. The method according to claim 1, further comprising communicating a piece of information representative of the determined play to a user, the communication comprising displaying the representative piece of information.

15. A control system for controlling a play in a flight control surface of an aircraft comprising:
an excitation module configured to send a sinusoidal excitation signal;
a measuring module configured to measure a response signal corresponding to an evolution of a parameter representative of a response of the flight control surface to the sinusoidal excitation signal; and
a processing module configured to determine a characteristic variable of an odd harmonic of the response signal other than the first harmonic of the response signal and to determine the play from the characteristic variable with an abacus curve.

16. The system according to claim 15, wherein the processing module is configured to determine a ratio between values of the characteristic variable of the response signal, the ratio being that of a value of the characteristic variable corresponding to the first harmonic of the response signal to a value of the characteristic variable corresponding to the odd harmonic of the response signal, the processing module also being configured to determine the play by comparing the determined ratio with the abacus curve.

17. The system according to claim 15, wherein the processing module is integrated into an avionics system of the aircraft or is integrated into an external housing configured to be separated from the aircraft and to be connected on an actuator of the flight control surface.
